(19) United States
(12) Patent Application Publication
(10) Pub. No.: US 2024/0012351 A1
(43) Pub. Date: Jan. 11, 2024

(54) FIXING DEVICE AND IMAGE FORMING APPARATUS INCORPORATING THE SAME

(71) Applicant: Yoshiki SUGAWARA, Tokyo (JP)

(72) Inventor: Yoshiki SUGAWARA, Tokyo (JP)

(21) Appl. No.: 18/204,951

(22) Filed: Jun. 2, 2023

(30) Foreign Application Priority Data
Jul. 5, 2022 (JP) 2022-108574
Mar. 24, 2023 (JP) 2023-048864

(51) Int. Cl. G03G 15/20

(52) U.S. Cl. CPC G03G 15/2053; G03G 15/2064; G03G 2215/2035

(57) ABSTRACT

A fixing device includes a fixing rotator, a heater, a support, and a backup pad. The fixing rotator includes a flexible hollow rotator. The heater heats the fixing rotator. The support supports the fixing rotator. The backup pad supports the fixing rotator from an inner circumferential surface of the fixing rotator in a fixing area where the fixing rotator comes into contact with a recording medium. The backup pad includes a stay and a sliding sheet. The stay has a first friction coefficient between the sliding sheet and the inner circumferential surface of the fixing rotator, and the first friction coefficient is smaller than a second friction coefficient between the stay and the inner circumferential surface of the fixing rotator.

### CROSS-REFERENCE TO RELATED APPLICATIONS

This patent application is based on and claims priority pursuant to 35 U.S.C. § 119(a) to Japanese Patent Applications No. 2022-108574, filed on Jul. 5, 2022, and No. 2023-048864, filed on Mar. 24, 2023, in the Japan Patent Office, the entire disclosures of which are hereby incorporated by reference herein.

### BACKGROUND

### Technical Field

Embodiments of the present disclosure generally relate to a fixing device and an image forming apparatus incorporating the fixing device.

### Related Art

One type of image forming apparatus includes a fixing device. The fixing device includes a fixing rotator including a flexible hollow rotator, a backup member that supports the fixing rotator from an inner circumferential surface of the fixing rotator at a fixing area where the fixing rotator contacts a recording medium, and a heat source that heats the fixing rotator.

### SUMMARY

This specification describes an improved fixing device that includes a fixing rotator, a heater, a support, and a backup pad. The fixing rotator includes a flexible hollow rotator. The heater heats the fixing rotator. The support supports the fixing rotator. The backup pad supports the fixing rotator from an inner circumferential surface of the fixing rotator in a fixing area where the fixing rotator comes into contact with a recording medium. The backup pad includes a stay and a sliding sheet. The stay has a thermal conductivity lower than a thermal conductivity of the support. The sliding sheet is on the stay and has a first friction coefficient between the sliding sheet and the inner circumferential surface of the fixing rotator. The first friction coefficient is smaller than a second friction coefficient between the stay and the inner circumferential surface of the fixing rotator.

This specification also describes an improved fixing device that includes a fixing rotator, a pressure rotator, a heater, and a pressure receiver. The fixing rotator includes a flexible hollow rotator. The pressure rotator presses a recording medium between an outer circumferential surface of the fixing rotator and the pressure rotator. The heater heats the fixing rotator. The pressure receiver receives a pressing force of the pressure rotator via the fixing rotator. The pressure receiver includes a stay and a sliding sheet on the stay. The sliding sheet has a first friction coefficient between the sliding sheet and the inner circumferential surface of the fixing rotator, and the first friction coefficient is smaller than a second friction coefficient between the stay and the inner circumferential surface of the fixing rotator. A thermal conductivity of the stay is lower than a thermal conductivity of the sliding sheet.

This specification further describes an image forming apparatus including the fixing device.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic view of an image forming apparatus according to an embodiment of this disclosure; and

FIG. 2 is an enlarged view of a fixing device.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

In the drawings illustrating embodiments of the present disclosure, elements or components having identical or similar functions or shapes are given similar reference numerals as far as distinguishable, and redundant descriptions are omitted.

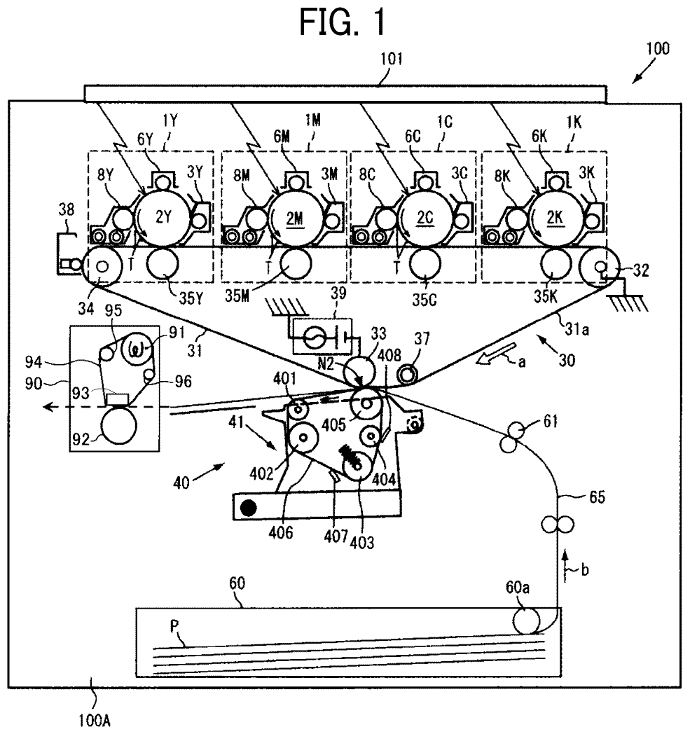

With reference to drawings, the following describes an embodiment of the present disclosure. FIG. 1 is a schematic view of a configuration of an image forming apparatus 100. In the present embodiment, the image forming apparatus 100 is an electrophotographic color printer. The image forming apparatus 100 includes four image forming units 1Y, 1M, 1C, and 1K to form yellow (Y), magenta (M), cyan (C), and black (K) toner images, a transfer unit 30 serving as an intermediate transfer device, a secondary transfer device 40 including a secondary transfer unit 41, a sheet tray 60 to contain recording media P as conveyed objects, and a fixing device 90 including a heating roller 91 and a pressure roller 92.

The four image forming units 1Y, 1M, 1C, and 1K form an image forming section and use toners of Y, M, C, and K that are different color toners as powder developers. The process units 1K, 1Y, 1M, and 1C have a similar structure except the color of toner. The image forming units 1Y, 1M. 1C, and 1K include drum-shaped photoconductors 2Y, 2M, 2C, and 2K serving as image bearers, photoconductor cleaners 3Y, 3M, 3C, and 3K, dischargers, charging devices 6Y, 6M, 6C, and 6K, developing devices 8Y, 8M, 8C, and 8K, respectively.

The surfaces of the photoconductors 2Y, 2M, 2C, and 2K are uniformly charged by the charging devices 6Y, 6M, 6C, and 6K and optically scanned by exposure light such as laser beams emitted from an optical writing device 101 disposed above the image forming units 1Y, 1M, 1C, and 1K to form electrostatic latent images for yellow, magenta, cyan, and black images, respectively. The developing devices 8Y, 8M, 8C, and 8K develop the electrostatic latent images on the photoconductors 2Y, 2M, 2C, and 2K with yellow, magenta, cyan, and black toners, into visible toner images T, respectively. Thus, the toner images T are formed on the photoconductors 2Y, 2M, 2C, and 2K.

The toner image T is primarily transferred from each of the photoconductors 2Y, 2M, 2C, and 2K onto an outer circumferential surface 31a of an intermediate transfer belt 31, which is an endless belt.

Below the image forming units 1Y, 1M, 1C, and 1K, the intermediate transfer unit 30, serving as a belt unit and a primary transfer device, is disposed. The transfer unit 30 includes the intermediate transfer belt 31 rotating clockwise in FIG. 1. In the present embodiment, a direction of rotation of the intermediate transfer belt 31 is referred to as a “belt travel direction” indicated by an arrow a in FIG. 1.

In addition to the intermediate transfer belt 31, the transfer unit 30 includes a drive roller 32, a secondary-transfer backup roller 33, a cleaning backup roller 34, four primary transfer rollers 35Y, 35M, 35C, and 35K, and a pre-transfer roller 37. The intermediate transfer belt 31 is looped around and stretched taut between the drive roller 32, the secondary-transfer backup roller 33, the cleaning backup roller 34, the four primary transfer rollers 35Y, 35M. 35C, and 35K, and the pre-transfer rollers 37. As a driver such as a drive motor drives and rotates the drive roller 32 clockwise, the intermediate transfer belt 31 rotates clockwise.

Outside and below the loop of the intermediate transfer belt 31, the secondary transfer device 40 including the secondary transfer unit 41 is disposed. The secondary transfer unit 41 includes a secondary transfer belt 406 as a transfer rotator. The secondary transfer belt 406 is entrained around a separation roller 401, a driven roller 402, a tension roller 403 serving as a first blade facing roller and a tension applicator, a second blade facing roller 404, and a secondary transfer roller 405. The secondary transfer unit 41 also includes a plurality of cleaners 407 and 408.

Below the secondary transfer device 40 in FIG. 1, the sheet tray 60 is disposed. The sheet tray 60 is a container to store a bundle of recording media P. In the sheet tray 60, a roller 60a contacts an uppermost recording medium P of the bundle of recording media and rotates at a predetermined timing to feed the recording medium P from the sheet tray 60 to a conveyance path 65 toward a secondary transfer nip N2. Then, a registration roller pair 61 forwards the recording medium P in the conveyance path 65 to the secondary transfer nip N2, so that the recording medium P coincides with the toner image on the outer circumferential surface 31a of the intermediate transfer belt 31 in the secondary transfer nip N2.

In the secondary transfer nip N2, the toner image on the outer circumferential surface 31a of the intermediate transfer belt 31 is collectively transferred onto the recording medium P by a secondary transfer electric field and a nip pressure applied thereto, thereby forming a full-color toner image in combination with white color of the recording medium P.

The fixing device 90 is disposed downstream from the secondary transfer nip N2 in a conveyance direction b of the recording medium P. The fixing device 90 receives the recording medium P onto which the full-color toner image is transferred and softens toner in the full-color toner image to fix the full-color toner image onto the recording medium P. After the full-color toner image is fixed on the recording medium P, the recording medium P is ejected from the fixing device 90 to an outside of the image forming apparatus 100.

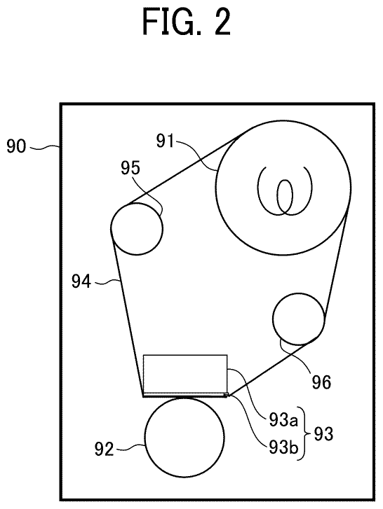

FIG. 2 is an enlarged view of the fixing device 90. As illustrated in FIG. 2, the fixing device 90 includes the heating roller 91, the pressure roller 92, a backup pad 93, a fixing belt 94, a tension roller 95, and a support roller 96. The fixing belt 94 as a fixing rotator is an endless belt and a flexible hollow rotator. The fixing belt 94 is looped over the heating roller 91, the backup pad 93, the tension roller 95, and the support roller 96. The heating roller 91, the tension roller 95, and the support roller 96 are supports supporting the fixing belt together with the backup pad 93. The tension roller 95 is movably supported and pressed against the fixing belt 94 to apply tension to the fixing belt 94. The heating roller 91 includes a heater in its inside to heat the fixing belt 94. The pressure roller 92 is in contact with the fixing belt 94 on the backup pad 93 to form a fixing nip as a fixing area. The recording medium P comes into contact with the fixing belt 94 in the fixing area to fix the toner image onto the recording medium P. The backup pad 93 is in contact with an inner circumferential surface of the fixing belt 94 and supports the fixing belt 94 in the fixing area.

In the present embodiment, the above-described parts are driven as follows. A drive motor in the image forming apparatus 100 transmits driving force to the pressure roller 92, and the pressure roller 92 drives the fixing belt 94. The driven fixing belt 94 drives other rollers. The drive motor may transmit the driving force to another roller instead of the pressure roller 92.

After the full-color toner image is transferred to the recording medium P, the recording medium P is conveyed to the fixing device 90. In the fixing device 90, the recording medium P is sandwiched by the pressure roller 92 and the fixing belt 94 on the backup pad 93 in the fixing nip in which the fixing belt 94 is in contact with the pressure roller 92. The heating roller 91 heats the fixing belt 94, and the fixing belt 94 heats the recording medium P in the fixing nip. In addition, the pressure roller 92 and the fixing belt 94 supported by the backup pad 93 presses the recording medium P in the fixing nip. The heat and pressure fixes the full-color toner image onto the recording medium P.

In the fixing device 90 according to the present embodiment, the backup pad 93 is fixed in the fixing device 90, which is different from a fixing device including the fixing belt and a backup roller to form the fixing nip. Specifically, the backup pad 93 includes a stay 93a having both ends fixed on both side plates of the fixing device 90. In the present embodiment, the stay 93a has a smooth surface facing the inner circumferential surface of the fixing belt 94.

In addition to the stay 93a, the backup pad 93 includes a sliding sheet 93b as a slide aid. The sliding sheet 93b has higher slidability (in other words, a smaller friction coefficient) with respect to the inner circumferential surface of the fixing belt 94 than the stay 93a. In other words, the sliding sheet 93b has a first friction coefficient between the sliding sheet 93b and the inner circumferential surface of the fixing belt 94, and the first friction coefficient is smaller than a second friction coefficient between the stay 93a and the inner circumferential surface of the fixing belt 94. The sliding sheet 93b is disposed on a surface of the stay 93a facing the inner circumferential surface of the fixing belt 94. The sliding sheet 93b has, for example, an upstream end in the rotation direction of the fixing belt 94 that is fixed to the stay 93a and a free downstream end in the rotation direction that is not fixed to the stay 93a. The sliding sheet 93b has a size that covers the entire surface of the stay 93a facing the inner circumferential surface of the fixing belt 94.

In the fixing device 90 according to the present embodiment, the thermal conductivity of the stay 93a is smaller than that of at least one of the heating roller 91, the tension roller 95, and the support roller 96 serving as supports supporting the fixing belt 94. Preferably, the thermal conductivity of the stay 93a is smaller than that of each of the supports. The stay 93a having the smaller thermal conductivity can prevent wasteful heat transfer from the fixing belt 94 to the side plates via the backup pad 93 as compared with the stay having a large thermal conductivity. Specifically, the stay 93a can prevent the heat transferred from the fixing belt 94 to the sliding sheet 93b from wastefully transferring to the body of the image forming apparatus via the side plates of the fixing device.

Accordingly, the thermal conductivity of the sliding sheet 93b may not be set to be small to prevent the wasteful heat transfer from the fixing belt 94. For example, the thermal conductivity of the sliding sheet may be set to reduce the temperature difference between a sheet passing region and a non-sheet passing region. As a result, a manufacturing method of the sliding sheet becomes simple, and the cost increase of the sliding sheet can be avoided. In addition, bringing the fixing belt 94 into contact with the tension roller 95 and the support roller 96 that each have relatively high thermal conductivity can reduce the temperature difference between the sheet passing region and the non-sheet passing region.

Examples of materials and thermal conductivities of the support roller 96, the tension roller 95, the stay 93a, and the sliding sheet 93b as the slide aid are as follows. The support roller 96 and the tension roller 95 are made of carbon steel and have a thermal conductivity of about 43 [W/m·K]. The stay 93a is made of, for example, glass fibers or ceramic. The thermal conductivity is 0.24 to 0.3 [W/m·K]. Such materials are supplied commercially, for example, by MISUMI CO., LTD. The sliding sheet 93b may be made of, for example, polytetrafluoroethylene (PTFE). In this case, the thermal conductivity of the sliding sheet 93b is about 0.25 [W/m·K]. Alternatively, in order to reduce the temperature difference between the sheet passing region and the non-sheet passing region, the sliding sheet 93b may be made of graphite. The above-described thermal conductivity is a value measured under a room temperature.

The above-described embodiments are illustrative and do not limit this disclosure. Thus, numerous additional modifications and variations are possible in light of the above teachings. For example, elements and/or features of different illustrative embodiments may be combined with each other and/or substituted for each other within the scope of this disclosure. For example, the number of support roller 96 is not limited to one but may be two or more. The image forming apparatus is not limited to the printer and may be, for example, a copier, a stand-alone fax machine, or a multifunction peripheral including at least two functions of a copier, a printer, a fax machine, and a scanner.

The fixing device may employ a free belt nip system using a fixing belt having a relatively high hardness. In the fixing device of this type, the fixing belt is sandwiched by a pressure rotator in contact with the outer circumferential surface of the fixing belt and a pressure receiver in contact with the inner circumferential surface of the fixing belt to form the fixing nip, and a guide is disposed in a portion other than the fixing nip to restrict a trajectory of the fixing belt. The fixing device of this type does not include a support roller for applying a tension to the belt. The above-described fixing device may be configured as described above to prevent the wasteful heat transfer from the fixing belt. That is, the pressure receiver may include the stay and the sliding sheet on the stay. The sliding sheet has the higher slidability than the surface of the stay with respect to the inner circumferential surface of the fixing belt. In other words, the sliding sheet has a first friction coefficient between the sliding sheet and the inner circumferential surface of the fixing belt, and the first friction coefficient is smaller than a second friction coefficient between the stay and the inner circumferential surface of the fixing belt. The thermal conductivity of the stay is smaller than the thermal conductivity of the sliding sheet, and both ends of the stay are supported by both side plates of the fixing device. As a result, the wasteful heat transfer is prevented.

The effects obtained by the above-described embodiment are examples. The effects according to the present disclosure are not limited to the above-described effects.

The above-described embodiment is one of examples, and the present disclosure has following aspects.

(First Aspect)

In a first aspect, a fixing device (90) includes a fixing rotator (94), a heater, a support (91, 95, 96), and a backup pad (93). The fixing rotator (94) includes a flexible hollow rotator. The heater heats the fixing rotator (94). The support (91, 95, 96) supports the fixing rotator (94). The backup pad (93) supports the fixing rotator from an inner circumferential surface of the fixing rotator (94) in a fixing area where the fixing rotator comes into contact with a recording medium. The backup pad includes a stay (93a) and a sliding sheet (93b). The stay (93a) has a thermal conductivity lower than a thermal conductivity of the support (91, 95, 96). The sliding sheet (93b) is on the stay (93a) and has a first friction coefficient between the sliding sheet (93b) and the inner circumferential surface of the fixing rotator (94), and the first friction coefficient is smaller than a second friction coefficient between the stay (93a) and the inner circumferential surface of the fixing rotator (94).

The configuration according to the first aspect can prevent the wasteful heat transfer from the fixing rotator to the body of the image forming apparatus via the sliding sheet and the stay as described in the embodiment. As a result, the configuration according to the first aspect can prevent occurrence of unstable fixing performance caused by a temperature drop in the fixing area due to the heat transfer.

(Second Aspect)

In a second aspect, the fixing device according to the first aspect further includes multiple supports including the support, and the thermal conductivity of the stay is smaller than each of thermal conductivities of the multiple supports.

(Third Aspect)

In a third aspect, the backup pad in the fixing device according to the first aspect or the second aspect has a smooth surface in contact with the inner circumferential surface of the fixing rotator.

(Fourth Aspect)

In a fourth aspect, the support in the fixing device according to any one of the first to the third aspects is a rotatable support roller.

(Fifth Aspect)

In a fifth aspect, the support in the fixing device according to any one of the first to fourth aspects includes a heating roller, and the heater is inside the heating roller.

(Sixth Aspect)

In a sixth aspect, the support in the fixing device according to any one of the first to fifth aspects includes a tension roller pressed to move in a direction that increases a tension applied to the fixing rotator.

(Seventh Aspect)

In a seventh aspect, the fixing device according to any one of the first to sixth aspects further includes a pressure rotator pressed against an outer circumferential surface of the fixing rotator in the fixing area to press the recording medium.

(Eighth Aspect)

In an eighth aspect, a fixing device includes a fixing rotator, a pressure rotator, a heater, and a pressure receiver. The fixing rotator includes a flexible hollow rotator. The pressure rotator presses a recording medium between an outer circumferential surface of the fixing rotator and the pressure rotator. The heater heats the fixing rotator. The pressure receiver receives a pressing force of the pressure rotator via the fixing rotator. The pressure receiver includes a stay and a sliding sheet on the stay. The sliding sheet has a first friction coefficient between the sliding sheet and the inner circumferential surface of the fixing rotator, and the first friction coefficient is smaller than a second friction coefficient between the stay and the inner circumferential surface of the fixing rotator. A thermal conductivity of the stay is lower than a thermal conductivity of the sliding sheet.

(Ninth Aspect)

In a ninth aspect, an image forming apparatus includes the fixing device according to any one of the first to eighth aspects.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A fixing device comprising:
a fixing rotator including a flexible hollow rotator;
a heater configured to heat the fixing rotator;
a support supporting the fixing rotator; and
a backup pad supporting the fixing rotator from an inner circumferential surface of the fixing rotator in a fixing area where the fixing rotator comes into contact with a recording medium, the backup pad including:
a stay having a thermal conductivity lower than a thermal conductivity of the support; and
a sliding sheet on the stay, the sliding sheet having a first friction coefficient between the sliding sheet and the inner circumferential surface of the fixing rotator, the first friction coefficient being smaller than a second friction coefficient between the stay and the inner circumferential surface of the fixing rotator.

2. The fixing device according to claim 1, further comprising
multiple supports including the support,
wherein the thermal conductivity of the stay is smaller than each of thermal conductivities of the multiple supports.

3. The fixing device according to claim 1,
wherein the backup pad has a smooth surface in contact with the inner circumferential surface of the fixing rotator.

4. The fixing device according to claim 1,
wherein the support is a rotatable support roller.

5. The fixing device according to claim 1,
wherein the support includes a heating roller, and the heater is inside the heating roller.

6. The fixing device according to claim 1,
wherein the support includes a tension roller pressed to move in a direction that increases a tension applied to the fixing rotator.

7. The fixing device according to claim 1, further comprising
a pressure rotator configured to be pressed against an outer circumferential surface of the fixing rotator on the fixing area to press the recording medium.

8. An image forming apparatus comprising the fixing device according to claim 1.

9. A fixing device comprising:
a fixing rotator including a flexible hollow rotator;
a pressure rotator configured to press a recording medium between an outer circumferential surface of the fixing rotator and the pressure rotator:
a heater configured to heat the fixing rotator; and
a pressure receiver configured to receive a pressing force of the pressure rotator via the fixing rotator, the pressure receiver including:
a stay; and
a sliding sheet on the stay, the sliding sheet having a first friction coefficient between the sliding sheet and an inner circumferential surface of the fixing rotator, the first friction coefficient being smaller than a second friction coefficient between the stay and the inner circumferential surface of the fixing rotator,
wherein a thermal conductivity of the stay is lower than a thermal conductivity of the sliding sheet.

10. An image forming apparatus comprising the fixing device according to claim 9.
